(19) United States
(12) Patent Application Publication
(10) Pub. No.: US 2023/0179025 A1
(43) Pub. Date: Jun. 8, 2023

(54) INDUCTIVELY POWER CAMERA

(71) Applicant: AAMP of Florida, Inc., Clearwater, FL (US)

(72) Inventor: Nathaniel Lee Wincek, Clearwater, FL (US)

(21) Appl. No.: 18/075,200

(22) Filed: Dec. 5, 2022

Related U.S. Application Data
(60) Provisional application No. 63/285,858, filed on Dec. 3, 2021.

(51) Int. Cl. H02J 50/10; H04N 23/51; H04N 7/18; H04N 7/04; H04N 23/695; B60R 1/28

(52) U.S. Cl. CPC H02J 50/10; H04N 23/51; H04N 7/183; H04N 7/04; H04N 23/695; B60R 1/28; B60R 2300/10; B60R 2300/20; B60R 1/24

(57) ABSTRACT

An inductively powered camera device including a housing including a base portion configured to be mounted to an exterior surface of a window of a vehicle, a camera supported by the housing and configured to collect image data, an inductive power pad supported by the housing, the inductive power pad in electrical communication with the camera and configured to provide power to the camera, and an inductive power puck configured to be mounted to an interior surface of the window, the inductive power puck configured to inductively provide power to the inductive power pad through the window of the vehicle.

### CROSS-REFERENCE TO RELATED APPLICATION(S)

This application claims priority to U.S. Provisional Patent Application No. 63/285,858, filed on Dec. 3, 2021, the entire contents of which are fully incorporated herein by reference.

The present invention relates to cameras mounted on vehicles.

### BACKGROUND

Modern vehicles are often equipped with at least one built in camera to assist a driver in maneuvering the vehicle. For example, many modern vehicles are equipped with a backup camera.

### SUMMARY

The present disclosure provides, in one embodiment, an inductively powered camera device including a housing including a base portion configured to be mounted to an exterior surface of a window of a vehicle, a camera supported by the housing and configured to collect image data, an inductive power pad supported by the housing, the inductive power pad in electrical communication with the camera and configured to provide power to the camera, and an inductive power puck configured to be mounted to an interior surface of the window, the inductive power puck configured to inductively provide power to the inductive power pad through the window of the vehicle.

The present disclosure provides, in another embodiment, an inductively powered camera device including a housing having a base portion configured to be mounted to a first side of a surface, a camera supported by the housing and configured to collect image data, a first wireless transceiver disposed within the housing, the first wireless transceiver configured to wirelessly transmit the image data, an inductive power pad supported by the housing, the inductive power pad in electrical communication with the camera and configured to provide power to the camera, an inductive power puck configured to be mounted to a second side of the surface opposite the first side of the surface, the inductive power puck configured to inductively provide power to the camera via the inductive power pad, and a second wireless transceiver disposed within the inductive power puck, the second wireless transceiver configured to receive image data from the first wireless transceiver.

The present disclosure provides, in yet another embodiment, an inductively powered camera system, the system including a camera device including a housing having a base portion configured to be mounted to a first side of a non-metal surface, a camera supported by the housing and configured to collect image data, a wireless transceiver supported by the housing, the wireless transceiver configured to wirelessly transmit the image data, and an inductive power pad supported by the housing, the inductive power pad in electrical communication with the camera and configured to provide power to the camera. The system further includes an inductive power puck configured to be mounted to a second side of the non-metal surface, the inductive power puck configured to inductively provide power to the inductive power pad through the non-metal surface, and a camera module in communication with a display screen, the camera module configured to receive the image data and display the image data on the display screen.

Other aspects of the invention will become apparent by consideration of the detailed description and accompanying drawings.

### BRIEF DESCRIPTION OF THE DRAWINGS

FIG. 1 is a diagram of a camera capturing image data.

FIG. 2 is a schematic of an inductively powered camera system including a camera device configured to transmit image data to a wireless receiver connected to a camera module.

FIG. 3 is a bottom perspective view of an inductively powered camera device.

FIG. 4a is a sectional view of an inductively powered camera device configured to communicate wirelessly with a wireless transceiver disposed in a vehicle.

FIG. 4b is a sectional view of an inductively powered camera device configured to communicate wirelessly with a wireless transceiver disposed in an inductive power puck.

FIG. 5 is a front view of a vehicle having two inductively powered camera devices affixed to the windshield.

FIG. 6 is a detailed view of an inductive power puck coupled to an internal side of a windshield.

FIG. 7 is a detailed view of an inductively powered camera device affixed to an external side of a windshield.

FIG. 8 is a schematic view of a vehicle equipped with an inductively powered camera system.

FIG. 9 is a schematic of an inductively powered camera system including a camera device configured to transmit image data to a wireless transceiver disposed in an inductive power puck configured to power the camera device.

FIG. 10 illustrates an inductively powered camera system installed on a window of a building.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

Vehicle camera systems are often hardwired to a source of electricity onboard the vehicle. When a camera is installed on a vehicle as an aftermarket part (i.e., not part of the Original Manufacture Equipment (OEM) assembly done at the factory), this hardwiring generally requires a complicated and time-consuming installation. Installation of an aftermarket camera may require disassembly and reassembly of portions of the vehicle. Additionally, installation of wired cameras often involves disassembly of portions of the vehicle to route wiring for the cameras. For example, a vehicle door or quarter panel may need to be disassembled so that wiring harnesses or gaskets can have wires drawn through them when installing a camera. As another example, the upholstery of the vehicle may need to be removed in order to hide wiring beneath it. There is also risk of damaging parts during the installation process. Some of the components of the vehicle that need to be disassembled in order to install an aftermarket camera tend to be some of the more difficult or complex components to remove. Additionally, some of the typical locations to run wires for aftermarket cameras, such as through door frames, have little space to accommodate additional wiring for the camera. Further, hardwiring often means that the cameras are fixtures on the vehicle that must be installed in predetermined positions, and that cannot be removed from those positions.

Wired security systems for residential and commercial buildings also require complicated and time-consuming installations. Not only is installing these systems complicated and time-consuming, but installation may require drilling and installation of wire conduits in walls. Additionally, these installations tend to make expensive electronic recording, processing, and power conditioning equipment vulnerable to theft by leaving it exposed on an exterior of the subject structure. Accordingly, provided herein is a camera system including one or more camera devices that may be wirelessly powered and wirelessly transmit camera data.

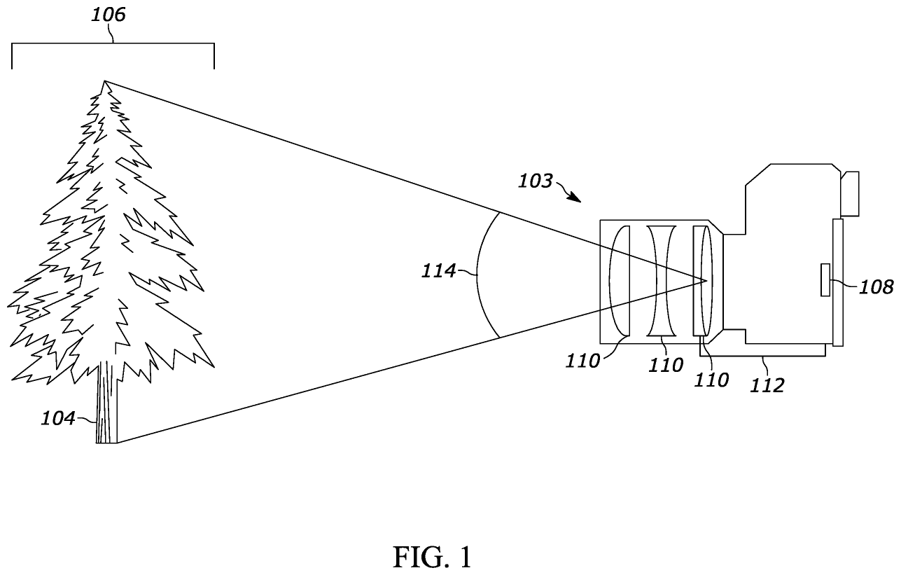

FIG. 1 illustrates an exemplary camera 103 configured to capture a subject 104 in a scene 106. The camera 103 comprises a sensor 108 and one or more lens 110 (or lens package). The camera 103 defines a focal length 112 and a field of view 114. The camera 103 can be oriented to capture the subject 104 or scene 106 by orienting the lens 110 toward the subject 104 and scene 106 and adjusting the focal length 112 so that the angle of view 114 captures at least one of the subject 104 or scene 106. The type of camera and/or camera features may vary depending on whether the camera 103 is intended for use as a hitch camera, cargo camera, sideview camera, rearview camera, or forward facing camera. For example, if the camera 103 is a rearview camera or a side view camera, the camera 103 may have a wider field of view 114 or greater focal length 112 than if the camera 103 is intended for use as a cargo camera.

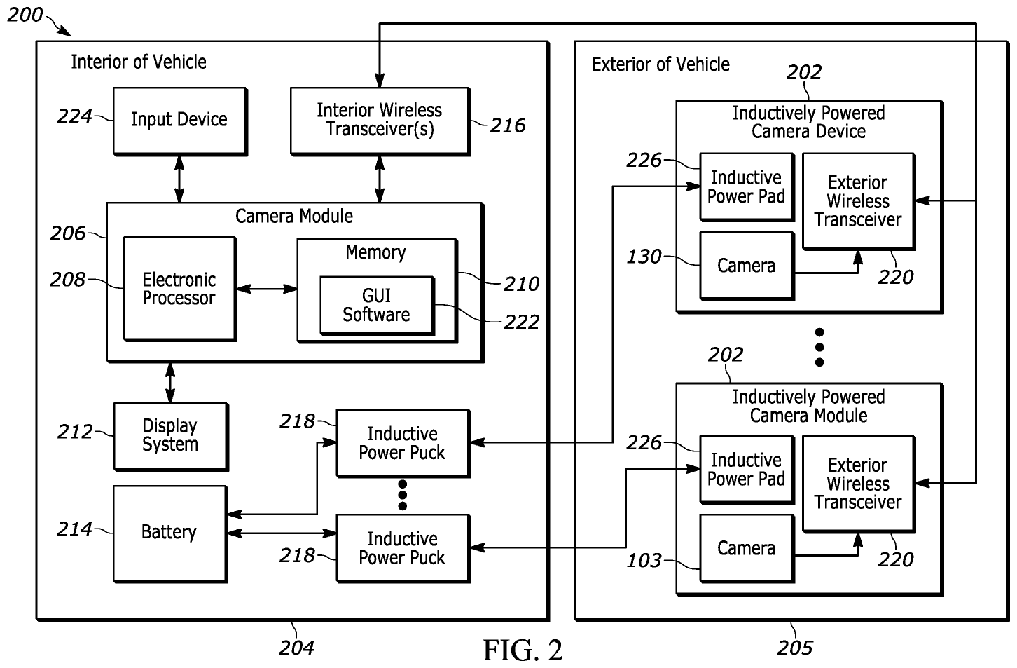

FIG. 2 is a schematic diagram illustrating an exemplary camera system 200 according to one embodiment. It should be understood that certain portions of the system 200 may be grouped together or organized differently than the arrangement show in FIG. 2. The illustrated embodiment provides a camera system 200 including two inductively powered camera devices 202. However, it should be understood that other embodiments may include a single camera device 202 or a greater number of camera devices 202. Each camera device 202 includes a camera 103, an inductive power pad 226, and a wireless transceiver 220. The camera system 200 is installed on a vehicle 204 equipped with a camera module 206, a display system 212, one or more interior wireless transceivers 216, one or more inductive power puck 218, and a battery 214. In some embodiments, one or more of these items may be installed on the vehicle as an aftermarket part when the camera device 202 is installed. Each camera device 202 may be installed on a window or other exterior portion of the vehicle. Each camera device 202 is inductively powered by the battery 214 via the inductive power pad 226 and the inductive power puck 218. The inductive power puck 218 transmits power from the battery 214 to the power pad 226 to ultimately provide power to the camera 103 and the wireless transceiver 220. Image data collected by the camera 103 is wirelessly transmitted to the camera module 206 via the exterior wireless transceiver 220 and the interior wireless transceiver 216. In turn, the camera module 206 transmits the image data from the camera 103 to the display system 212.

The camera device(s) 202 may be installed on a window or other exterior portion of the vehicle composed of glass or plastic (or any other non-conductive material). The camera device 202 is generally installed on a non-retractable window that does not open by retreating into an interior portion of the vehicle, such as the door. The installation window may be of the type that pivots open and closed without retracting. For example, the camera device may be installed on the windshield, a non-retractable side window, or a rear window. The exact position and orientation of the camera device 202 depends on whether the camera device 202 is intended for use as a hitch camera, a cargo camera, a sideview camera, a rearview camera, or a forward facing camera. The camera device 202 may be installed on the vehicle 204 using various adhesives, such as but not limited to, double sided tape (e.g., 3M Adhesive, doubled side foam core), glue, or magnets.

As will be described in further detail below, the inductive power puck 218 may be installed in a location corresponding to a location of the camera device 202 so that the inductive power puck 218 and the inductive power pad 226 are aligned for inductive transmission of power. For example, if the camera device 202 is positioned on the exterior of a windshield of the vehicle with the inductive power pad 226 pressed against the glass, the inductive power puck 218 will be positioned on the interior side of the windshield and aligned with the inductive power pad 226 with the glass positioned therebetween. Because the inductive power puck 218 is located within the vehicle, hardwiring the inductive power puck 218 to the battery 214 is generally easier than hardwiring the camera device 202 to the vehicle 204. The inductive power puck 218 may be installed on the inside of the vehicle 204 by the same or a similar method as the camera device 202 using various adhesives, such as but not limited to, double sided tape (e.g., 3M Adhesive, doubled side foam core), glue, or magnets. Power may be inductively transferred through the glass of the windshield. In some embodiments, the Qi protocol is used for transferring between 3.3V to 12V power between the inductive power puck 218 and the inductive power pad 226. In other embodiments, other inductive power protocols are used.

Each camera 103 is configured to collect image data, which may include one or both pictures and video. Each of the plurality of inductively powered camera devices 202 transmits the image data collected by an associated camera 103 to the interior wireless transceiver 216 via an exterior wireless transceivers 220 disposed in the inductively powered camera devices 202. The interior wireless transceiver 216 may be disposed in a dashboard or head unit/radio unit of the vehicle 204, in or around the inductive power puck 218, or some other location in the vehicle 204. For example, in some embodiments, the interior wireless transceiver 216 is located within the housing of the inductive power puck 218, while in other embodiments, the interior wireless transceiver 216 is located in a radio unit or the dashboard of the vehicle 204.

The interior wireless transceiver 216 transmits the image data to the camera module 206. The camera module 206 includes an electronic processor 208 and a memory 210. In some embodiments, the interior wireless transceiver 216 is a part of the camera module 206. The camera module 206 interprets the image data and displays it via display system 212, using the GUI software 222 of the camera module 206. In some embodiments, image data captured by the camera 103 is transmitted by the exterior wireless transceiver 220 using a 2.4 ghz signal, Bluetooth transmission, or other wireless protocols. In such embodiments, the interior wireless transceiver 216 may be configured to listen for the image data by listening in particular for transmissions at the frequency transmitted by each of the interior wireless transceiver 216. The interior wireless transceiver 216 may also achieve such communication by pairing directly, one-to-one, with each of the exterior wireless transceivers 220.

The camera module 206 is installed in the wiring system (not shown) of the vehicle 204. In some embodiments, the camera module 206 is installed behind the display system 212. In some embodiments, the camera module 206 and/or the display system 212 is part of a factory (or OEM) head unit or radio system installed by the manufacturer during assembly of the vehicle 204. Alternatively, in some embodiments, the camera module 206 and/or the display system 212 is installed as an aftermarket part and may be installed in, near, or as the head unit or radio system of the vehicle 204. The camera module 206 may be hooked into a wiring harness of the display system 212 and may intercept and relay communications between an Electronic Communication Unit (ECU) of the vehicle 204 and the display system 212. In such cases, the camera module 206 may also interpret and modify such communications and generate original signals or communications and communicate them to the ECU or display system 212. For example, the GUI software 222 may be configured to generate a graphical user interface (GUI) having a home page and display it via the display system 212.

The GUI software 222 is configured to display the image data to a user of the vehicle 204 via the display system 212. In some embodiments, the GUI software 222 is configured to automatically display the image data in response to a particular condition. For example, when the camera 103 is used as a rearview camera, the GUI software 222 may automatically display the image data upon receiving a signal that the vehicle 204 has been placed in a reverse state. In some embodiments, the plurality of inductively powered camera devices 202 are distributed in different positions on the vehicle 204, and the GUI software 222 displays labeled image data streams from one or more of the inductively powered camera devices 202. For example, the GUI software 222 may label an image data stream from a rear facing camera 103 as “rear view” and display both the image data stream and the associated label via the display system 212. Furthermore, in some embodiments, the GUI software 222 may be configured to display image data from more than one camera device 202 at a time through a split/divided display screen. In some embodiments, the display system 212 displays a graphical user interface (not shown) generated by the GUI software 222 in response to a user interacting with the input device 224 in a particular manner. For example, the display system 212 may be configured to display the graphical user interface in response to the user holding down a “home” button of the input device 224 for a predetermined period of time (e.g., 2 seconds). Additionally, in some embodiments, the memory 210 is configured to store image data received by the camera module 206, and the GUI software 222 is configured to facilitate review of image data stored in memory 210 by a user in response to the user interacting with the input device 224.

An input device 224 (e.g., a user input screen and/or buttons) in communication with the camera module 206 can be used to alter, select, organize, and filter, the way in which the image data is displayed. For example, the user input device 224 may be a touch screen included in the display system 212 and configured to allow a user to select a specific cameras 103 from the plurality of inductively powered camera devices 202 from which image data is desired to be viewed. The camera module 206 then uses GUI software 222 to display the image data from the selected cameras 103 via display system 212. In some embodiments, the input device 224 can also be used to change the field of view 114 and/or direction of the camera 103. For example, in some embodiments, the camera device 202 may include a motor within the housing 328, which allows the camera 103 to be adjusted, such as moving from a rearview camera angle to a cargo camera angle. For example, in some embodiments, the camera 103 may be movable within the housing such that it can rotate and/or slide relative to the housing to obtain different camera angles. In such instances, the motor may also be inductively powered in the same manner as the camera 103. Alternatively, the camera 103 may use software to electronically adjust the angle or zoom or field of view of the camera 103.

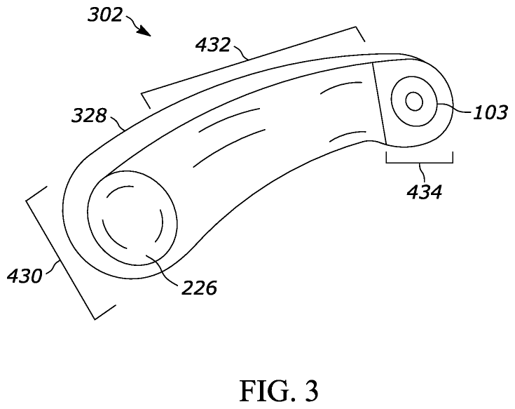

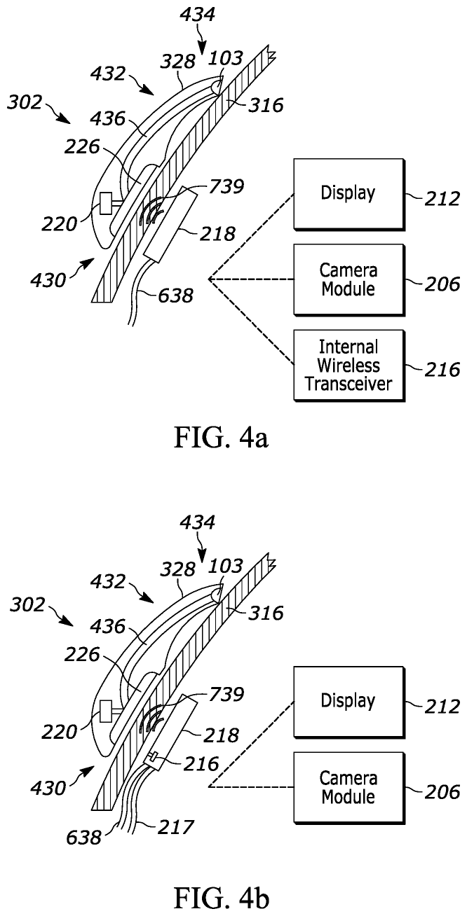

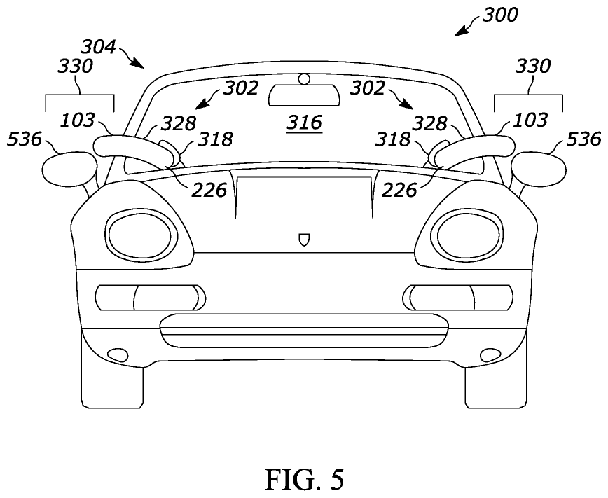

FIGS. 3 and 4a-b illustrate one example of a camera device 302 for use with the inductively powered camera system 200 in accordance with one embodiment of the present disclosure. The inductively powered camera device 302 comprises a housing 328 including a base portion 430, an arm portion 432, and a tip portion 434. The base portion 430 includes the inductive power pad 226, and the tip portion 434 includes the camera 103. The arm portion 432 may take on various shapes and configurations depending on how the camera 103 should be oriented relative to the inductive power pad 226. For example, when the power pad 226 is coupled to a windshield and the camera 103 is design as a side view camera, the arm portion 432 may take on a curved shape to wrap the tip portion 434 around to the side of the vehicle to orient the camera 103 to face the side of the vehicle 204 (e.g., as shown in FIG. 5). The camera device 302 may have an elongated shaped with a slim profile. For example, in some embodiments, the camera device 302 may be between 5 mm and 15 mm in thickness. In some embodiments, the housing is flexible (i.e., malleable or bendable). For example, the direction the camera 103 faces may be adjusted by adjusting a flexible portion (e.g., the arm portion 432) of the housing 328 supporting the camera 103. As another example, the base portion 430 of the housing 328 may be malleable and therefore facilitate highly adaptable installation of the housing 328 on curved or uneven surfaces using various adhesives, such as but not limited to, double sided tape (e.g., 3M Adhesive, doubled side foam core), glue, or magnets.

An electrical conductor 436 connects the inductive power pad 226 and the camera 103. The electrical conductor 436 (shown in FIG. 4) is configured to deliver power from the inductive power pad 226 to the camera 103, and may be additionally configured to deliver power to other components of the camera device 302, such as the exterior wireless transceiver 220. In some embodiments, the electrical conductor 436 is an electrical bus. In another embodiment, the electrical conductor 436 is a collection of wires or conductive traces. In some embodiments, the power pad 226 is separate from the base portion 430, but still configured to deliver power to the camera 103 and other components of the camera device 202 via the conductor 426. For example, the power pad 226 may be connected to the housing 328 of the camera device 302 via a conductive wire and be configured to be affixed to a surface at a distance from the housing 328, while still being configured to deliver power to the camera 103 via the wire and the conductor 436.

FIGS. 4a-b illustrate the inductive power puck 218 inductively communicating power to the inductive power pad 226 through a piece of glass—specifically, a windshield 316. The inductive power puck 218 transmits power to the inductive power pad 226 via an inductive power exchange 739. The inductive power pad 226, in turn, transmits power via electrical conductor 436 to camera 103. The camera 103 captures image data of a scene and communicates the image data through electrical conductor 436 to an exterior wireless transceiver 220 located within the housing 328 of the camera device 302. In the illustrated embodiment, the exterior wireless transceiver 220 is positioned within the housing 328 on an end near the inductive power pad 226. However, in other embodiments, the exterior wireless transceiver 220 is positioned towards an end of the housing 328 near the camera. In some embodiments, the exterior wireless transceiver 220 receives power from the inductive power pad 226 via the electrical conductor 436. The exterior wireless transceiver 220 wirelessly transmits the camera data to the camera module 206 via the interior wireless transceiver 216. The camera module 206 then transfers the image data to a display system 212. It should be understood that the camera module 206, the interior wireless transceiver 216, and/or the display system may be part of a single unit or may be a separate elements that communicate with one another.

In the embodiment shown in FIG. 4b, the interior wireless transceiver 216 is disposed in the inductive power puck 218. The exterior wireless transceiver 220 and the interior wireless transceiver 216 are positioned in relatively close proximity such that they can communicate using relatively close-range wireless communications protocols (e.g., Bluetooth protocol) when attached to opposite surfaces of the windshield 316. Specifically, the close proximity of the exterior wireless transceiver 220 and the interior wireless transceiver 216 makes for low latency, uninterrupted transmissions between the exterior wireless transceiver 220 and the interior wireless transceiver 216, even at high speeds of vehicle travel. Additionally, in the embodiment shown, a data wire 217 connected to the inductive power puck 218 and to the interior wireless transceiver 216 carries image data received by the interior wireless transceiver 216 from the exterior wireless transceiver 220 to the camera module 206. In some embodiments, multiple inductively powered camera devices 302 are each paired with an equal number inductive power pucks 218 in a one-to-one fashion. In these embodiments, the inductive power pucks 218 may include an interior wireless transceiver 216 disposed therein, and a plurality of data wires 217 may connect the plurality of interior wireless transceivers 216 to a central camera module 206. The interior wireless transceivers 216 of the inductive power pucks 218 may receive image data from the exterior wireless transceivers 220 disposed in the camera devices 302 and transfer the image data to the central camera module 306. The central camera module 206 may analyze the image data, catalog the image data in memory, or display the image data via a display (e.g., display system 212).

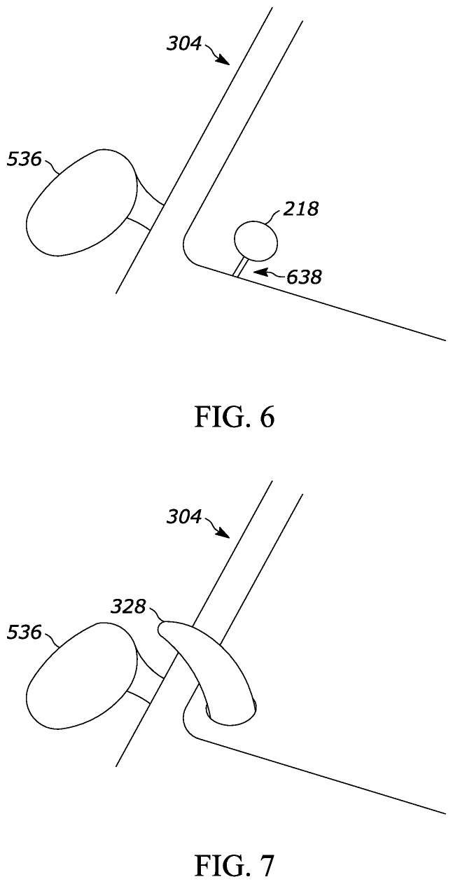

FIGS. 5-7 illustrate an inductively powered camera system 300 mounted on a surface of a windshield 316 of a vehicle 304. A pair of inductively powered camera devices 302 are coupled to the lower left and right corners of an external surface of the windshield 316, respectively. FIG. 6 illustrates an inductive power puck 618 attached to an internal surface of the windshield 316. Power wiring 638 delivers power from the battery 214 of the vehicle 304 to the inductive power puck 218. The inductive power puck 618 is configured to inductively communicate power to the inductive power pad 226 and thereby power the camera device 302. FIG. 7 illustrates the camera device 302 extending from an external surface of the bottom corner of the windshield 316 into the space 330 at the side of the vehicle 304. The camera device 302 is arranged on the windshield 316 to align the inductive power pad 226 on the outside of the windshield 316 with the inductive power puck 218 on the inside of the windshield 316. Each of inductively powered camera devices 302 comprises a housing 328 and a camera 103. The housings 328, and particularly the arm portion 432 of the housing 328, of the inductively powered camera devices 302 are sized and shaped to orient the camera 103 toward a desired location around the vehicle 304. In the embodiment shown, the inductively powered camera devices 302 wrap around the edge of the vehicle 304 in order to direct the camera 103 toward a space 330 at the side of the vehicle 304. Specifically, each camera device 302 extends from an external portion of the bottom corner of the windshield 316, around the side of the windshield 316, and up over a portion of the side view mirrors 536 of the vehicle 304.

However, the inductively powered camera devices 302 may also be positioned in different locations on the vehicle 304 and arranged to face the rear end of the vehicle 204, the front of the vehicle 204, a cargo area, or truck bed. For example, in some embodiments, a camera device 302 may be positioned on a rear window of a car or truck so that the camera 103 may be directed towards a truck bed or towards a rear end of the vehicle. Also, in some embodiments, the same camera 103 may be reoriented or adjusted to face a desired area at a desired time. Further, the inductively powered camera devices 302 and/or the corresponding inductive power pucks 218 may be affixed to various plastic or glass surfaces of the vehicle 304 by double sided adhesive tape, a double sided foam core adhesive pad, fasteners, permanent adhesive, magnetism (e.g., a permanent magnet or electromagnet), etc.

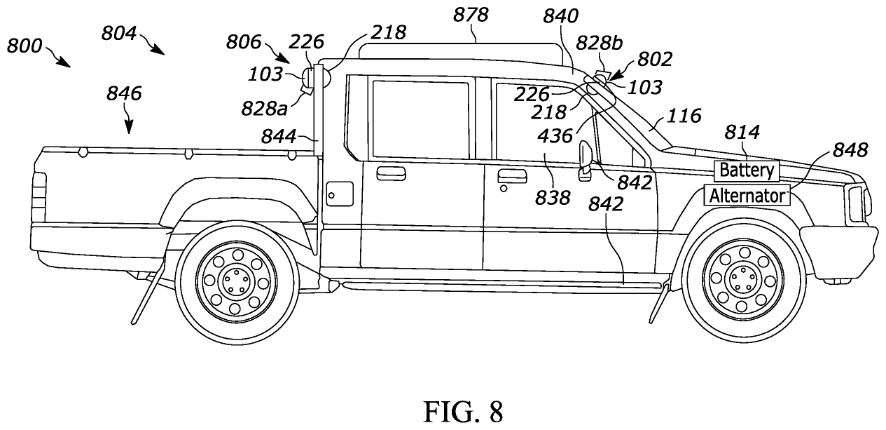

FIG. 8 illustrates another embodiment of an inductively powered camera system 800 installed in a vehicle 804. In the embodiment shown, the vehicle 804 is a truck including two inductively powered camera devices 802 and 806, each including a housing 828a, 828b (respectively), a camera 103, an inductive power pad 226, and an exterior wireless transceiver (not labeled in FIG. 8). Each of the inductively powered camera devices 802 and 806 receive power through a glass window via an inductive power puck 218 positioned on the opposite side of the window. Specifically, the inductive power pucks 218 are arranged inside of the vehicle 804 and are hardwired to a power source (e.g., battery 814, or alternator 848) of the vehicle 804. The inductive power pucks 218 may draw power from any of the battery 814, the alternator 848, or a renewable energy resource 878 (e.g., a solar panel). For example, the inductive power pucks may be configured to draw power first from the alternator 848, then from the renewable energy resource 878, then from the battery 814.

The inductively powered camera devices 802, 806 are each positioned and oriented to produce image data of a particular part or area of the vehicle 804. The first inductively powered camera device 802 is positioned on a windshield 116 of the vehicle 804 and the second inductively powered camera device 806 is positioned on a rear window 844 of the vehicle 804. The first and second inductively powered camera devices 802 and 806 may be the same style of camera devices or may be different from one another. For example, each of the inductively powered camera devices 802 and 806 may have a different field of view 114 or may have a different size or shape to direct the respective cameras 103 within each inductively powered camera device 802, 806 towards the desired area. For example, the housing 828a of the inductively powered camera device 806 is configured to orient the respective camera 103 toward a bed 846 or cargo area of the vehicle 804. In some embodiments, the inductively powered camera device 806 includes more than one camera 103. For example, the housing 828a may support a second camera 103 where the housing 828a is configured to orient the second camera 103 rearward toward traffic behind the truck, rather than downward towards the bed 846 of the truck.

Additionally, although the inductively powered camera devices 802, 806 are shown as affixed to the windshield 116 and the rear window 844 of the vehicle 804, the inductively powered camera devices 802, 806 may be disposed in various positions and on various windows or features of the vehicle and may comprise variously shaped housings 828a, 828b. For example, inductively powered camera devices 802, 806 may be affixed to the top corners of the windshield 116 of the vehicle 804 near the center-top position of the windshield 116, on a side window 838 of the vehicle 804, on the roof 840 of the vehicle 804, on plastic trim 842 of the vehicle 804 (e.g., a skirt or side mirror of the vehicle 804), etc.

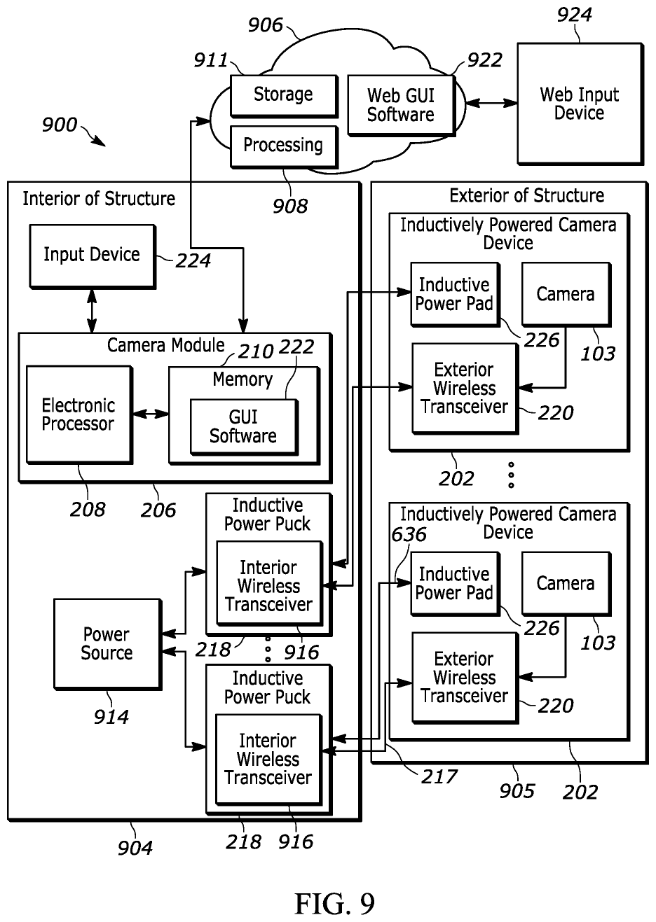

FIG. 9 is a schematic of an inductively powered camera system 900 including a camera device 302 configured to transmit image data to an interior wireless transceiver 216 disposed in an inductive power puck 218 configured to power the camera device 202. The illustrated embodiment provides a camera system 200 including two or more inductively powered camera devices 302. Each camera device 302 includes a camera 103, an inductive power pad 226, and an exterior wireless transceiver 220. The camera system 200 is installed in part in an interior of a structure 904. The portion of the camera system 200 installed in the interior of the structure 904 includes a camera module 206, one or more interior wireless transceiver 216, one or more inductive power puck 218, and a power source 914. Each camera device 302 is installed on an exterior of the structure 905 (e.g., on an exterior window). In the embodiment shown, the structure may be a building or a vehicle. Each camera device 302 is inductively powered by the power source 914 via the inductive power pad 226 and the inductive power puck 218. The power source 914 may be an AC power source or a DC power source. Although not shown, a power conditioning circuit may be connected between the power source 914 and the inductive power puck 218 and configured to condition power from the power source 914 for transmission by the inductive power puck 218 to the inductive power pad 226. The inductive power puck 218 transmits power from the power source 914 to the power pad 226 to ultimately provide power to the camera 103 and the exterior wireless transceiver 220. Image data collected by the camera 103 is wirelessly transmitted via the exterior wireless transceiver 220 to the interior wireless transceiver 216 of the inductive power puck 218. The inductive power puck 218 transmits the image data to the camera module 206 via data wire 217. In turn, the camera module 206 transmits the image data from the camera 103 to a cloud computing system 906, where the image data may be stored in a storage system 911 or processed (e.g., analyzed using image analysis) by a processing system 908.

The inductive power puck 218 may be installed in a location of the structure corresponding to the location of the camera device 302 so that the inductive power puck 218 and the inductive power pad 226 of the camera device 302 are aligned for inductive transmission of power. For example, if the camera device 302 is positioned on the exterior the structure 905 with the inductive power pad 226 pressed against the glass, the inductive power puck 218 will be positioned on the interior of the structure 904 and aligned with the inductive power pad 226 with the glass of a window, siding, or some other material through which inductive power transmission can be accomplished positioned therebetween. In this way, the camera module 206 may be placed in the interior of the structure 904, where it is less vulnerable to theft, yet receive image data wirelessly from camera devices 302 positioned on the exterior of the structure 904.

A web input device 924 (e.g., a smart device, a personal computer, a mobile phone, television etc.) in communication with the cloud computing system 906 can be used to alter, select, organize, filter, and view image data via a display (not shown) of the web input device 924. For example, the web input device 924 may be configured to allow a remote user to select a specific cameras 103 from the plurality of inductively powered camera devices 302 from which image data is desired to be viewed. GUI software (not shown) may be used to display the image data from the selected cameras 103 via a display screen (not shown) of the web input device 924. The cloud computing system 906 may provide access to web GUI software 922 configured to provide such a GUI at the web input device 924. In some embodiments, the web input device 924 can also be used to change the field of view 114 and/or direction of the camera 103 using the web GUI software. For example, in some embodiments, the web input device 924 may be used to zoom, pan, crop, etc. the field of view of the camera device 302. Further, in some embodiments, both stored image data and live image data may be viewed using the web input device 924.

In some embodiments, the camera module 206 is configured to upload collected image data to the storage system 911 of the cloud computing system 906. In such embodiments, the web input device 924 may be configured to access, review, or edit the stored image data via the web GUI software 922. Additionally, in some embodiments, the processing system 908 of the cloud computing system 906 may be used to perform image analysis on stored or live streamed image data transmitted to the cloud computing system 906 by the camera module 206. For example, the processing system 908 may be used to perform image analysis on stored image data to determine when particular events happened (e.g., a break-in event, a loss of cargo event, etc.).

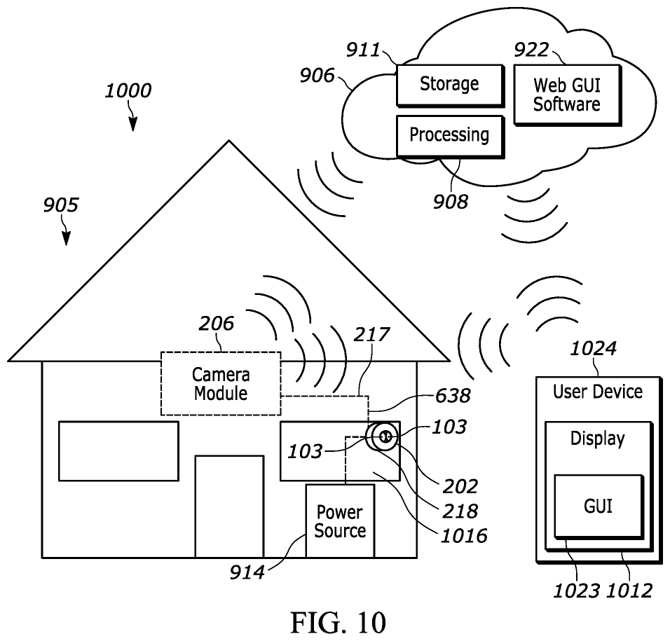

FIG. 10 illustrates an inductively powered camera system installed on a window 1016 of a building 905. A camera device 302 is attached to an exterior of the window 1016, and an inductive power puck 218 is attached to an interior of the window 1016. A power wire 638 connects the power source 914 to the inductive power puck 218. In the embodiment shown, the power source 914 is a power supply including a AC to DC rectifier connected to a standard residential AC power outlet. A data wire 217 connects an interior wireless transceiver (not shown) of the inductive power puck 218 to the camera module 206. Oppositely facing cameras 103 are powered via the inductive power puck 218 and may be configured to produce complimentary image data. For example, the camera module 206 may stitch the image data from the oppositely facing cameras 103 together to form an image having a 180 degree field of view. Similarly, the processing system 908 of the cloud computing system 906 may perform such stitching. The camera module 206 may also transmit the image data to the cloud computing system 906, where the image data can be processed, viewed, edited, or stored via the user device 1024. The user device 1024 includes a display 1012 and may be used to connect to the cloud computing system 906 or to the camera module 206. A GUI 1023 for establishing such a connection may be downloaded from the cloud computing system 906 to the user device 1024 as web GUI software 922. The user device 1024 may also connect to the camera module 206 where the image data may be processed, viewed (e.g., live streamed), edited, or stored via a user device 1024. In this way, some embodiments of the disclosed inductively powered camera system 200, 900 may also be used as a security system for buildings.

The embodiments described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention. Various features and advantages of the invention are set forth in the following claims.

What is claimed is:

1 An inductively powered camera device comprising:
a housing including a base portion configured to be mounted to an exterior surface of a window of a vehicle;
a camera supported by the housing and configured to collect image data;
an inductive power pad supported by the housing, the inductive power pad in electrical communication with the camera and configured to provide power to the camera; and
an inductive power puck configured to be mounted to an interior surface of the window, the inductive power puck configured to inductively provide power to the inductive power pad through the window of the vehicle.

2. The device of claim 1, further comprising a wireless transceiver disposed within the housing, the wireless transceiver configured to wirelessly communicate with a camera module disposed within the vehicle, the camera module configured to display the image data from the camera on a display screen.

3. The device of claim 1, further comprising:
a first wireless transceiver disposed within the housing, and
a second wireless transceiver disposed within the power puck, the second wireless transceiver configured to wirelessly receive the image data captured from the camera.

4. The device of claim 3, wherein the power puck transfers the image data to a camera module via a hardwire connection.

5. The device of claim 4, wherein the camera module includes an electronic processor configured to display the image data from the camera on a display screen.

6. The device of claim 4, wherein the display screen includes at least one from the group consisting of a radio head unit, a smart device, and a mobile phone.

7. The device of claim 1, wherein the inductive power puck draws power from a power source, the power source including at least one selective form the group consisting of a car battery, an alternator, and a rechargeable battery.

8. The device of claim 1, wherein the inductive power pad is positioned within the base portion of the housing, and wherein the camera is positioned on a tip of the housing opposite the base portion.

9. The device of claim 8, wherein the housing is flexible at least between the base and the tip to adjust the orientation of the camera relative to the base.

10. An inductively powered camera device comprising:
a housing including a base portion configured to be mounted to a first side of a surface;
a camera supported by the housing and configured to collect image data;
a first wireless transceiver disposed within the housing, the first wireless transceiver configured to wirelessly transmit the image data;
an inductive power pad supported by the housing, the inductive power pad in electrical communication with the camera and configured to provide power to the camera;
an inductive power puck configured to be mounted to a second side of the surface opposite the first side of the surface, the inductive power puck configured to inductively provide power to the camera via the inductive power pad; and
a second wireless transceiver disposed within the inductive power puck, the second wireless transceiver configured to receive image data from the first wireless transceiver.

11. The device of claim 10, wherein the surface is composed of a material including at least one selective form the group consisting of glass, plastic, or a non-metal material, and wherein the inductive power puck is configured to transmit power to the inductive power pad through the surface.

12. The device of claim 10, wherein the inductive power puck draws power from a power source, the power source including at least one selected from the group consisting of a car battery and an alternator.

13. The device of claim 10, wherein the power puck is configured to send image data to a camera module, the camera module configured to display the image data from the camera on a display screen.

14. The device of claim 13, wherein the power puck sends image data to the camera module via at least one of the second wireless transceiver or a hardwired connection.

15. The device of claim 13, wherein the display screen includes at least one from the group consisting of a vehicle radio head unit, a smart device, a personal computer, a mobile phone, and a television.

16. The device of claim 10, wherein the camera is adjustable to allow the image data to capture different angles or field of views.

17. An inductively powered camera system, the system comprising:
a camera device including
a housing including a base portion configured to be mounted to a first side of a non-metal surface,
a camera supported by the housing and configured to collect image data,
a wireless transceiver supported by the housing, the wireless transceiver configured to wirelessly transmit the image data, and
an inductive power pad supported by the housing, the inductive power pad in electrical communication with the camera and configured to provide power to the camera;
an inductive power puck configured to be mounted to a second side of the non-metal surface, the inductive power puck configured to inductively provide power to the inductive power pad through the non-metal surface; and
a camera module in communication with a display screen, the camera module configured to receive the image data and display the image data on the display screen.

18. The system of claim 17, wherein the display screen includes at least one from the group consisting of a vehicle radio head unit, a smart device, a personal computer, a mobile phone, and a television.

19. The system of claim 17, wherein the camera module is configured to receive camera data via the wireless transceiver.

20. The system of claim 17, wherein the camera module is configured to receive camera data via the power puck.
